(19) United States
(12) Patent Application Publication
(10) Pub. No.: US 2013/0067129 A1
(43) Pub. Date: Mar. 14, 2013

(54) COMMUNICATION SYSTEM AND SLAVE NODE

(71) Applicants: Hideki Kashima, Kariya-shi (JP); Tomohisa Kishigami, Obu-shi (JP)

(72) Inventors: Hideki Kashima, Kariya-shi (JP); Tomohisa Kishigami, Obu-shi (JP)

(73) Assignee: DENSO CORPORATION, Kariya-city (JP)

(21) Appl. No.: 13/611,399

(22) Filed: Sep. 12, 2012

(30) Foreign Application Priority Data
Sep. 14, 2011 (JP) 2011-200635

(51) Int. Cl. G06F 13/36

(52) U.S. Cl. 710/110

(57) ABSTRACT

In a slave node, a signal processor stores therein wakeup information uniquely defined for the slave node. The signal processor includes a writing unit configured to write the wakeup information into the transceiver at a given timing. A transceiver includes a memory. The wakeup information is written into the memory to be held therein. The transceiver includes a wakeup determiner. The wakeup determiner compares information received via the communication bus with the wakeup information held in the memory if the slave node is operating in the sleep mode, and determines whether the slave node should shift to the wakeup mode according to a result of the comparison.

### CROSS REFERENCE TO RELATED APPLICATIONS

This application is based on Japanese Patent Application 2011-200635 filed on Sep. 14, 2011. This application claims the benefit of priority from the Japanese Patent Application, so that the descriptions of which are all incorporated herein by reference.

### TECHNICAL FIELD

The present disclosure relates to communication systems connected to a common communication bus, and configured to mutually communicate with each other via the common communication bus.

### BACKGROUND

Communication systems based on communication buses, such as

CAN buses and LIN buses, are frequently used as those which are installed in motor vehicles.

A typical example of communication systems of this type is comprised of a plurality of nodes each is comprised of, for example, a signal processor and a transceiver as an interface between the signal processor and one or more corresponding communication buses. The typical example of communication systems uses a master-slave communication protocol for communications between the nodes. For example, in the master-slave communication protocol, a master node transmits a header with an ID, and a slave node, which is associated with the ID of the header, transmits data as a response to a corresponding communication bus.

Particularly, each of the nodes is designed to operate in either a wakeup mode or a sleep mode. The wakeup mode is an operation mode in which a node can perform all functions (tasks) allocated thereto, and the sleep mode is an operation mode in which a node cannot perform at least some functions (tasks) in order to reduce power consumption. If each node of a communication system is operating in the sleep mode, the occurrence of a wakeup event, such as the switching on of a predetermined switch of the communication system, causes the node to shift to the wakeup mode according to a signal on a communication bus.

There have been known US Patent Application Publications No. 2009/0213915 and No. 2005/0204204, each of which discloses a method for selectively causing a slave node specified by a master node to sleep, and selectively waking up, i.e. activating, a slave node in the sleep mode; a slave node in the sleep mode will be referred to as a sleep slave node. The US Patent Application Publication No. 2009/0213915 corresponds to International Publication NO. WO 2008/504784, and the US Patent Application Publication No. 2005/0204204 corresponds to International Publications NO. WO 2005/529516 and WO 2005/529517.

For example, a sleeping slave node can be designed such that the signal processor is in the sleep mode and the transceiver, which can communicate with corresponding communication buses, is in the wakeup mode. This design allows the transceiver of a sleeping slave node to determine whether a wake-up message has been transmitted to the sleeping slave node via a communication bus, and to shift the signal processor to the wakeup mode if it is determined that the wake-up message has been transmitted to the sleeping slave node.

### SUMMARY

The known method is designed to transmit, to individual sleep slave nodes, wake-up messages to request them to wake up. Thus, it is necessary to uniquely produce the wake-up messages for the respective individual sleep slave nodes. In addition, the transceiver of each slave node is required to store therein its wake-up message that is required to determine whether a wake-up message transmitted from a master node is directed to its slave node.

Note that normal transceivers for these communication systems can be mass produced as general purpose products. However, because these transceivers each store therein a unique wake-up message, they are difficult to mass produce, and therefore communication systems based on the known method cannot use such general purpose transceivers, resulting in reduction of its productive efficiency.

In view of the circumstances set forth above, one aspect of the present disclosure seeks to provide communication systems each comprised of a master node and one or more slave nodes communicable to the master node via a communication bus, which are designed to address the problems set forth above.

Specifically, an alternative aspect of the present disclosure aims to provide such communication systems, which are designed to enable the usage of a general purpose transceiver in the one or more slave nodes while uniquely specifying a slave node to wake up. More specifically, a further aspect of the present disclosure aims to provide such communication systems, which are capable of uniquely specifying a sleep slave node and shifting the specified sleep slave node to a wakeup mode while keeping their productive efficiencies at high levels.

According to a first exemplary aspect of the present disclosure, there is provided a communication system. The communication system includes a communication bus; a master node; and a slave node communicably coupled to the master node via the communication bus. While the communication system is operating in a partial mode, the master node instructs the slave node, which is operating in a sleep mode, to shift to a wakeup mode. The wakeup mode is an operation mode in which the slave node enables execution of all functions allocated thereto. The sleep mode is an operation mode in which the slave node disables execution of at least some functions allocated thereto. The slave node includes a signal processor that stores therein wakeup information uniquely defined for the slave node. The signal processor includes a writing unit configured to write the wakeup information into the transceiver at a given timing. The signal processor includes a transceiver. The transceiver includes a memory. The wakeup information is written into the memory to be held therein. The transceiver includes a wakeup determiner that compares information received via the communication bus with the wakeup information held in the memory if the slave node is operating in the sleep mode, and determines whether the slave node should shift to the wakeup mode according to a result of the comparison.

According to a second exemplary aspect of the present disclosure, there is provided a slave node communicably coupled to a master node via a communication bus. While the master node is operating in a partial mode, the master node instructs the slave node to shift from a sleep mode to a wakeup mode. The wakeup mode is an operation mode in which the slave node enables execution of all functions allocated thereto. The sleep mode is an operation mode in which the slave node disables execution of at least some functions allocated thereto. The slave node includes a signal processor that stores therein wakeup information uniquely defined for the slave node. The signal processor includes a writing unit configured to write the wakeup information into the transceiver at a given timing. The slave node includes a transceiver. The transceiver includes a memory. The wakeup information is written into the memory to be held therein. The transceiver includes a wakeup determiner that compares information received via the communication bus with the wakeup information held in the memory if the slave node is operating in the sleep mode, and deter mines whether the slave node should shift to the wakeup mode according to a result of the comparison.

During the time the communication system or the master node is operating in the partial mode, it is necessary to set unique wakeup information to the slave node in order to instruct the slave node to shift to the wakeup mode from the sleep mode.

However, if the communication system were configured such that the slave node stores therein unique wakeup information, this configuration could reduce the productive efficiency of the communication system because it could be difficult to mass-produce the slave node.

In contrast, the communication system according to the first exemplary aspect (or the slave node according to the second exemplary aspect) is configured such that wakeup information uniquely defined for the slave node is stored in the signal processor of the slave node; this signal processor is uniquely designed for the slave node. This configuration allows the wakeup information to be written into the memory of the transceiver as a given timing.

Thus, it is possible for the slave node to determine whether information received via the communication bus is matched with the wakeup information held in the memory. That is, the configuration of the communication system makes it possible to shift the slave node, directed to shift to the wakeup mode, to the wakeup mode using a general purpose transceiver.

In a first structural example of each of the first and second exemplary aspects, the writing unit is configured to write the wakeup information into the memory of the transceiver when an instruction is sent from the master node via the communication bus, the instruction instructing the slave node to shift to the sleep mode.

In a second structural example of each of the first and second exemplary aspects, the slave node includes a power unit that supplies operating power to the signal processor, and when the slave node is operating in the sleep mode, the power source shuts off the supply of the operating power to the signal processor, and the wakeup determiner is configured to output, to the power source, a signal to restart supply of the operating power to the signal processor to shift the slave node to the wakeup mode when the information received via the communication bus is matched with the wakeup information held in the memory.

In a third structural example of each of the first and second exemplary aspects, transceiver includes a receiver that receives information transmitted via the communication bus, the receiver disables output of received information to the signal processor when the slave node is operating in the sleep mode, and the wakeup determiner is configured to output an enabling signal to the receiver for shifting the slave node to the wakeup mode when the information received via the communication bus is matched with the wakeup information held in the memory. The enabling signal enables the receiver to output the received information to the signal processor.

In a fourth structural example of each of the first and second exemplary aspects, the wakeup determiner is configured to determine that the slave node should shift to the wakeup mode even if no wakeup information is held in the memory.

In a fifth structural example of each of the first and second exemplary aspects, the memory is a nonvolatile memory.

The above and/or other features, and/or advantages of various aspects of the present disclosure will be further appreciated in view of the following description in conjunction with the accompanying drawings. Various aspects of the present disclosure can include or exclude different features, and/or advantages where applicable. In addition, various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall structure of a communication system according to an embodiment of the present disclosure;

FIG. 2A is a view schematically illustrating an example of a code signal used in a communication bus illustrated in FIG. 3;

FIG. 2B is a view schematically illustrating an example of the structure of a frame communicable through the communication bus;

FIG. 2C is a view schematically illustrating block data transmittable and receivable between an UART of a signal processor illustrated in FIG. 3 and a transceiver illustrated in FIG. 3;

FIG. 3 is a block diagram schematically illustrating an example of the structure of a master node and each slave node constituting the communication system illustrated in FIG. 1;

FIG. 4A is a flowchart schematically illustrating a wakeup-ID writing task carried out by a microcomputer of each slave node illustrated in FIG. 3;

FIG. 4B is a flowchart schematically illustrating a sleep-mode shifting task carried out by the microcomputer of each slave node illustrated in FIG. 3; and

FIG. 5 is a flowchart schematically illustrating a wakeup determination task carried out by a wakeup determination module of the transceiver of each slave node illustrated in FIG. 3.

### DETAILED DESCRIPTION OF EMBODIMENT

An embodiment of the present disclosure will be described hereinafter with reference to the accompanying drawings. In these embodiments, description of like parts to which like reference characters are assigned is omitted or simplified to avoid redundant description.

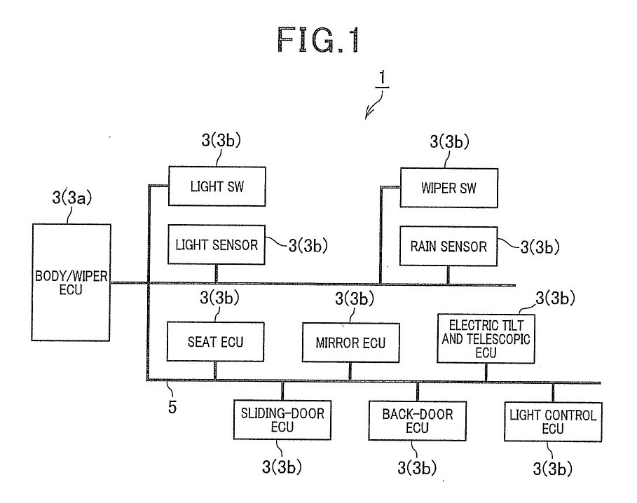

An example of the overall structure of a communication system 1 installed in a motor vehicle as a target vehicle according to this embodiment of the present disclosure is illustrated in FIG. 1.

The communication system 1 is comprised of a plurality of nodes 10 and communication buses 70 as communication routes through which the plurality of nodes 10 are communicably coupled to each other. Each node 10 is, for example, a hardware computing terminal or a software module. In the first embodiments, the nodes 10 include body ECUs for running body applications (application programs) for automotive-body parts, such as mirrors, door locks, windows, and so on of the target vehicle. The nodes 10 also include devices, such as lighting devices, actuators, and sensors, for measuring the operating conditions of the motor vehicle and for controlling the operating conditions of the target vehicle.

Referring to FIG. 1, the body ECUs of the nodes 10 include, for example, a body/wiper ECU, a seat ECU, a mirror ECU, a sliding-door ECU, a back-door ECU, a light control ECU, an electric tilt and telescopic ECU, and so on. The devices of the nodes 10 include, for example, a light switch (SW), a wiper switch, a light sensor, a rain sensor, and so on.

The wiper switch is normally OFF and turns ON when switched on by a driver of the target vehicle, and the rain sensor is configured to, for example, detect water droplets on the windshield of the target vehicle.

The body/wiper ECU is electrically connected to the rain sensor and a wiper actuator for driving the wiper of the automotive-body parts. The body/wiper ECU is configured to perform overall control of the automotive-body parts of the target vehicle and the other ECUs and all the switches, and particularly control the wiper actuator to activate or deactivate the wiper according to the ON/OFF state of the wiper switch and/or information detected by the rain sensor.

The seat ECU is electrically connected to an actuator for adjusting the position of each seat of the target vehicle. The seat ECU is configured to store therein an optimum position of each seat of the target vehicle and control the actuator for each seat to adjust the position of each seat to the corresponding optimum position when a corresponding power-seat switch is operated.

The sliding-door ECU is installed in the target vehicle if at least one sliding door is installed therein. Specifically, the sliding-door ECU is electrically connected to an actuator for automatically opening the at least one sliding door of the target vehicle when a corresponding door switch is switched with the at least one sliding door closed and for automatically closing the at least one sliding door when the corresponding door switch is switched with the at least one sliding door open.

The mirror ECU is electrically connected to an actuator for adjusting at least one mirror of the target vehicle. The mirror ECU is configured to control the actuator for the at least one mirror to angularly adjust the at least one mirror when a corresponding switch is operated.

The back-door ECU is installed in the target vehicle if a back door is installed therein. Specifically, the back-door ECU is electrically connected to an actuator for automatically opening the back door when a corresponding door switch is operated with the back door closed and for automatically closing the back door when the corresponding door switch is operated with the back door open.

The light switch is provided for each lighting device for illuminating a corresponding area around the target vehicle. The light switch is normally OFF and turns ON when switched on by the driver of the target vehicle. The light sensor is configured to measure a brightness level of illumination in front of the target vehicle.

The light control ECU is electrically connected to the light switch, the light sensor, and each lighting device and configured to control at least one lighting device according to the ON/OFF state of a corresponding one of the light switches and the brightness level of illumination measured by the light sensor.

The electric tilt and telescopic control ECU serves as an electric steering-position adjustment device and is configured to adjust the tilt and telescope of the steering wheel of the target vehicle.

The communication bus 70 according to this embodiment can have high and low signal levels, for example, high and low voltage levels. The communication bus 70 is designed such that, if a high level portion of a first signal and a low level portion of a second signal are simultaneously outputted to the communication bus 70, the low level portion appears on the communication bus 70, in other words, the second signal wins (the first signal loses) on bus arbitration.

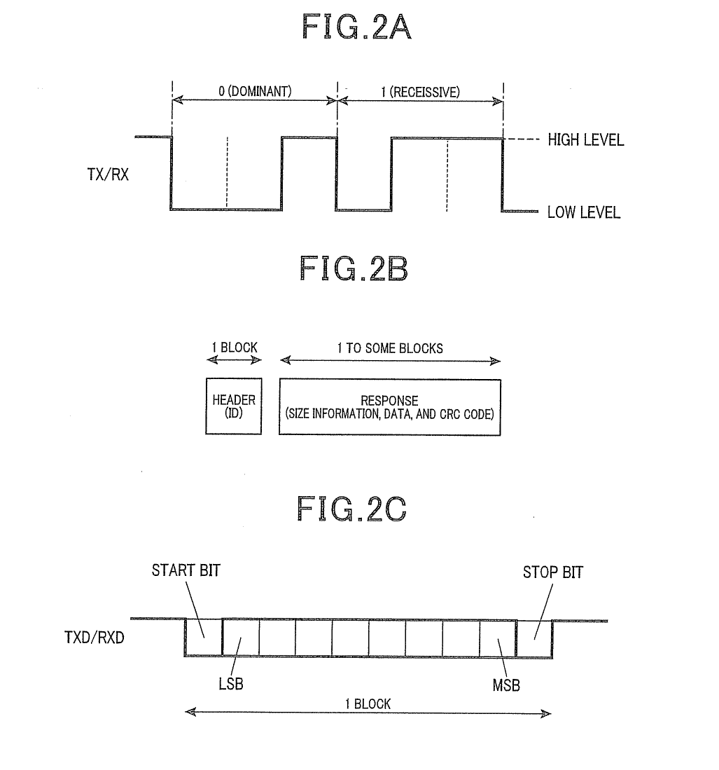

An example of code signals used for communications through the communication bus 70 will be described hereinafter with reference to FIG. 2A.

Referring to FIG. 2A, in this embodiment, a PWM code signal is used as an example of code signals for communications through the communication bus 70. The PWM code signal consists of a set of first and second PWM codes; each of the first and second PWM codes corresponds to a bit of data to be transmitted through the communication bus 70. The first and second PWM codes have predetermined first and second duty cycles different from each other; each of the first and second duty cycles is the ratio of a duration of a low signal level to a total duration corresponding to a duration of each bit of data to be transmitted through the communication bus 70. That is, the first duty cycle of the first PWM code signifies a bit 0 of data, and the second duty cycle of the second PWM code signifies a bit 1 of data.

Specifically, a bit 0 of data to be transmitted through the communication bus 70 is expressed as the first PWM code consisting of a set of logical values “001”. Similarly, a bit 1 of data to be transmitted through the communication bus 70 is expressed as the second PWM code consisting of a set of logical values “011”. The logical value 0 corresponds to the low signal level on the communication bus 70, and the logical value 1 corresponds to the high signal level on the communication bus 70. That is, the first duty cycle is greater than the second duty cycle. More specifically, the first one-third of a duration of a bit 0 of data to be transmitted through the communication bus 70 corresponds to a duration of a logical value 0 (the low signal level), the next one-third corresponds to a duration of a logical value 0, and the last one-third corresponds to a duration of a logical value 1 (the high signal level). Similarly, the first one-third of a duration of a bit 1 of data to be transmitted through the communication bus 70 corresponds to a duration of a logical value 0, the next one-third corresponds to a duration of a logical value 1, and the last one-third corresponds to a duration of a logical value 1.

Note that the first PWM code and second PWM code will be referred to as a dominant code (a dominant bit 0) and a recessive code (a recessive bit 1), respectively.

If the dominant code of a signal transmitted from a node 10 collides with the recessive code of another signal transmitted from an alternative node 10 on the communication bus 70, the dominant code wins on bus arbitration whereas the alternative node 10 loses thereon. For example, the communication system 1 according to this embodiment is configured based on CSMA/CA (Carrier Sense Multiple Access with Collision Avoidance). Thus, when obtaining the result of bus arbitration based on the state of the communication bus 70, the alternative node stops transmission of the signal, so that the node 10 wining bus arbitration continuously transmits the signal.

The nodes 10 according to this embodiment operate in accordance with a preselected master-slave protocol. In the master-slave protocol, one node 10 as a master node is designed to communicate with another node 10 as a slave node using frames each of which is a unit of data to be transmitted and received via the communication bus 70. FIG. 2B schematically illustrates the structure of a frame according to this embodiment.

As illustrated in FIG. 2B, a frame or a message frame is comprised of a header (H) for specifying data allowed to send by a master node 10, and a variable-length response including the data specified by the header. The header of a frame consists of an ID of data allowed to send by the master node 10. Such a frame is designed such that, the lower the value of the header is, the higher the possibility (probability) of the frame wining on bus arbitration is. The response of a frame at least includes corresponding data to be sent, information indicative of the size of the data (the size of the corresponding response), and a CRC (Cyclic Redundancy Check) code as an example of error detection codes for checking errors in the data. As a result, data is sent through the communication bus 70 as a frame (message frame) containing the set of a header and a response. One slot is allocated for one frame on the communication bus 70 and required for passing the one frame.

Note that an ID is a number allocated to data allowed to be sent for unique identification of the data.

Next, an example of the overall structure of each node 10 will be described.

In this embodiment, a body/wiper ECU in the nodes 10 serves as a master node (master) 3a, and the other nodes 10 serve as slave nodes (slaves) 3b.

In the master-slave protocol, the master 10a operates in a first communication mode (a regular communication mode) to successively send a header to successively designate pieces of data that corresponding slaves 10b are allowed to send, thus designating the corresponding slaves 10b as target slaves 10b requested to send the corresponding pieces of data. In other words, the master 10a performs polling of the slaves 10b. Each of the target slaves 10b designated by the header operates in the first communication mode to send a response (data).

In the master-slave protocol, each slave 10b operates in a second communication mode (event communication mode) to actively send data independent of instructions from the master 10a.

Each node 10 is designed to operate in either a wakeup mode, i.e. a wakeup state, or a sleep mode, i.e. sleep state. The wakeup mode is an operation mode in which each node 10 can perform all functions (tasks) allocated to a corresponding node, and the sleep mode is an operation mode in which each node 10 cannot perform at least some functions (tasks) in order to reduce power consumption.

The communication system 1 is designed to operate in a partial mode. While the communication system 1 is operating in the partial mode, the master 10a causes some slaves 10b operating in the wakeup mode to individually sleep, that is, shift to the sleep mode, and the master 10a causes some slaves 10b operating in the sleep mode to individually wake up, that is, individually shift to the wakeup mode.

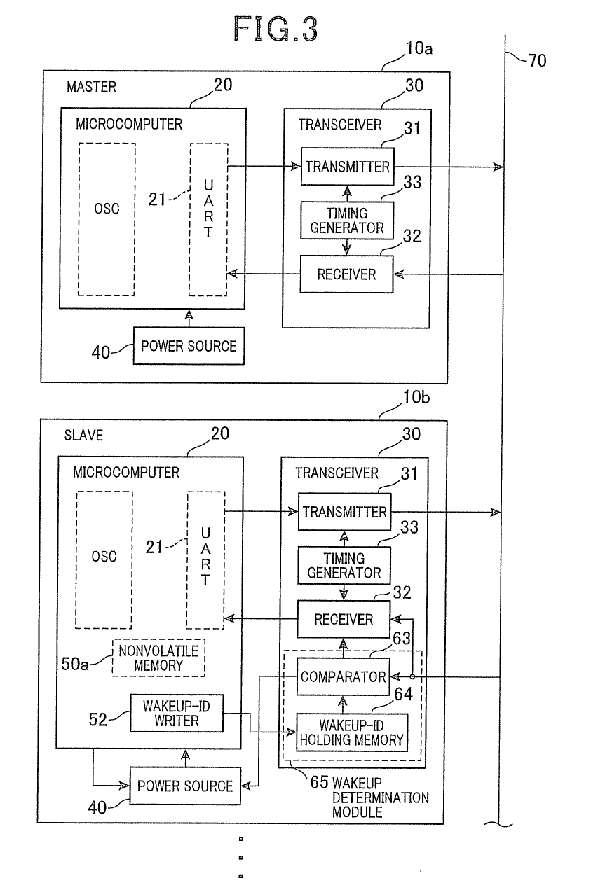

Hereinafter, examples of the structure of the master 10a and that of each slave 10b will be described with reference to FIG. 3.

The master 10a is comprised of a microcomputer 20, a transceiver 30, and a power source 40. The microcomputer 20 is communicable with the transceiver 30, and configured to carry out tasks allocated thereto based on information; the information has been obtained by communications between the master 10a and other nodes 10 via the communication bus 70. The transceiver 30 is connected with the communication bus 70, and configured to: encode transmission data TXD based on an NRZ (Non-Return to Zero) code, which is supplied from the microcomputer 20 with being asynchronous to the internal clock CK of the transceiver 30, into transmission data TX based on PWM code; and output the transmission data TX to the communication bus 70. In addition, the transceiver 30 is configured to receive data RX based on PWM code from the communication bus 70; decode the received data RX into received data RXD based on NRZ code, and supply the decoded data RXD to the microcomputer 20.

The microcomputer 20 consists of, for example, a CPU, a storage medium including a nonvolatile memory, an IO (Input and output) interface, and so on. Particularly, the microcomputer 20 is comprised of a UART (Universal Asynchronous Receiver Transmitter) 21 and an oscillator (OSC) 22.

The UART 21 is configured to carry out serial start-stop communications (serial asynchronous communications) at a predetermined data transfer rate (bit rate). The UART 21 can be designed as a hardware circuit or a software module. The oscillator 22 is configured to generate an operation clock on which the microcomputer 20 operates, and generate an internal clock with a predetermined rate substantially identical to the bit rate of the UART 21, thus supplying the internal clock to the transceiver 30.

In this embodiment, the oscillator 22 is designed using a quartz crystal oscillator, and therefore is capable of generating these clock signals with stable frequencies. The microcomputer 20 is configured to operate in either the wakeup mode or sleep mode in accordance with, for example, the operating state of the power source 40.

FIG. 2C schematically illustrates an example of the structure of each of data TXD transmitted from the UART 21 and data RXD received thereby. Referring to FIG. 2C, each of data TXD from the UART 21 and data RXD to be received thereby is designed as a block data, so that data TXD or RXD is transmitted or received data-block by data-block. The block of data TXD or RXD consists of a start bit (0 bit) with the low signal level, a configurable number of data bits (8 bits in this embodiment), and one or more stop bits (one stop bit in this embodiment) with the high signal level. That is, each of data TXD and data RXD according to this embodiment is designed as 10-bit block data. Each of data TXD and RXD is configured such that: the least significant bit (LSB) is allocated to the first bit of the 8-bit data as the main part of corresponding data TXD or RXD, and the most significant bit (MSB) is allocated to the last bit thereof.

In this embodiment, the header of a frame set forth above (see FIG. 2B) is comprised of single block data, seven bits of the 8-bit data of each data TXD/RXD are set to an ID, and the remaining one bit of the 8-bit data is used as a parity bit. A response to be sent from a node 10 is comprised of a predetermined number of, such as one or more, pieces of block data.

The size information can be stored in the first block in a response

Returning to FIG. 3, the transceiver 30 is comprised of a transmitter 31, a receiver 32, and a timing generator 33.

The timing generator 33 is equipped with a simple oscillator comprised of a ring oscillator; the ring oscillator consists of a plurality of inverters connected in ring form. The simple oscillator is configured to generate a counting clock. The timing generator 33 is configured to divide the counting clock to generate various timing signals each synchronized with the internal clock supplied from the signal processor 10.

The transmitter 31 is configured to encode data (transmission data) TXD according to timing signals generated by the timing signal generator 33, and transmit, to the communication bus 70, encoded data as encoded transmission data TX.

The receiver 32 is configured to capture data (signals) on the communication bus 70 as received data RX, and decode the received data RX according to timing signals generated by the timing generator 33 into received data RXD based on NRZ code. The receiver 32 is also configured to supply the decoded data RXD to the microcomputer 20.

Each of the transmitter 31 and the receiver 32 is configured to control operations of the timing generator 33 and its operations according to the mode signal MD supplied from the microcomputer 20.

As described above, in order to perform bus arbitration on the communication bus 70, the structure of the communication bus 70 and the part of the transmitter 31 can be constructed using, for example, a single wire, common open-collector circuits, and pull-up resistors. For example, a part of the receiver 32 is designed as a common comparator, and configured to output the high signal level if the level on the communication bus 70 is higher than a preset threshold level, and the low signal level if the level on the communication bus 70 is lower than the preset threshold level.

For example, each of the transmitter 31 and the receiver 32 is enabled to operate if the mode signal MD represents the wakeup mode, and is disabled to operate if the mode signal MD represents the sleep mode.

For example, the power source 40 is configured to be externally powered on or off. When powered on, the power source 40 is configured to supply operating power to the microcomputer 20, and when powered off, it is configured to shut off the power supply thereto.

If the power supply to the microcomputer 20 is shut off, the microcomputer 20 shifts to the sleep mode, and the power supply to the microcomputer 20 is restarted, the microcomputer 20 shifts to the wakeup mode.

Similarly, each slave 50b is comprised of a microcomputer 50, a transceiver 60, and a power supply 40, which are identical to the master 10a.

That is, the structure of each slave 10b is substantially identical to that of the master 10a except for the following points. Thus, description of some parts of each slave 10b, which are identical to those of the master 10a, are omitted or simplified with the same reference characters used in the master 10a assigned to these parts of each slave 10b.

Each slave 10b is specially comprised of a first structure that shifts to the sleep mode from the wakeup mode in response to a first shift instruction sent from the master 10a while the communication system 1 (i.e. the master 10a) is operating in the partial mode, and a second structure that shifts to the wakeup mode from the sleep mode in response to a second shift instruction sent from the master 10a while the communication system 1 (i.e. the master 10a) is operating in the partial mode.

Specifically, when the first shift instruction is sent from the master 10a to a slave 10b operating in the wakeup mode, the microcomputer 50 controls the power source 40 so that the power source 40 shuts off power supply to the microcomputer 50. As a result, the microcomputer 50 shifts to the sleep mode, and the transceiver 60 is continuously operating in the wakeup mode.

The master 10a operating in the partial mode sends, to a slave 10b operating in the sleep mode, a wakeup ID uniquely defined to the slave 10b as the second shift instruction, thus causing the slave 10b to shift to the wakeup mode. The wakeup ID is created by the microcomputer 20 as, for example, transmission data TX based on PWM code, and sent from the master 20 through the communication bus 70.

In order to determine whether a wakeup ID sent from the master 10a is matched with its wakeup ID, the transceiver 10b of each slave 10b is comprised of a wakeup determination module 65 including a comparator 63 and a wakeup-ID latching memory 64, and the microcomputer 50 of each slave 10b is comprised of a wakeup-ID writer 52. The wakeup determination module 65 except for the wakeup-ID holding memory 64 can be designed as a hardware circuit or a software module, and the wakeup-ID writer 52 can be designed as a hardware circuit or a software module.

Specifically, the microcomputer 50 of each slave 10b consists of, for example, a CPU, a storage medium including a nonvolatile memory 50a, an IO (Input and output) interface, and so on. In the nonvolatile memory 50a, a wakeup ID uniquely defined to the slave 10b is stored beforehand.

The wakeup-ID writher 52 is configured to read the wakeup ID stored in the nonvolatile memory 50a at a given timing, thus writing the wakeup ID into the wakeup-ID holding memory 64. The wakeup-ID holding memory 64 is a nonvolatile memory, so that the wakeup ID written in the wakeup-ID holding memory 64 is continuously held independently of whether the slave 10b is powered on or off.

When transmission data TX is sent from the master 10a in the first communication mode, the wakeup determination module 65 receives the transmission data TX as received data RX, and the comparator 63 of the wakeup determination module 65 compares the received data RX with the wakeup ID held in the wakeup-ID holding memory 64 bit by bit. When determining that the received data RX is matched with the wakeup ID held in the wakeup-ID holding memory 64 using the results of comparison, the wakeup determination module 65 sends, to the receiver 32, a reception enabling signal to the receiver 32. The reception enabling signal enables the receiver 32 to transmit received data RX based on transmission data TX on the communication bus 70 to the microcomputer 50. In addition, the wakeup determination module 65 outputs, to the power source 40, a power-supply restart signal; the power supply restart signal enables the power source 40 to restart power supply to the microcomputer 50, so that the microcomputer 50 shifts from the sleep mode to the wakeup mode.

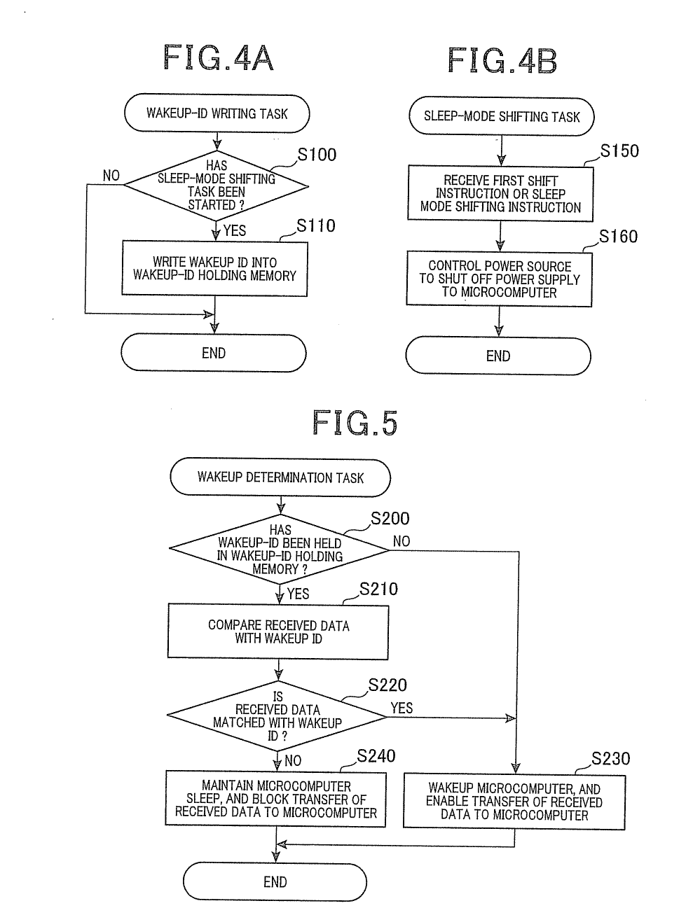

Next, a wakeup-ID writing task carried out by the microcomputer 50 of each slave 10b, particularly, by the wakeup-ID writer 52, will be described hereinafter with reference to FIG. 4A. The wakeup-ID writing task is, for example, cyclically performed by the microcomputer 50 of each slave 10b.

In step S100 of the wakeup-ID writing task, the microcomputer 50 determines whether a sleep-mode shifting task has been started. As described above, when the first shift instruction directed to its slave 10b is sent from the master 10a operating in the partial mode, the microcomputer 50 starts to perform the sleep-mode shifting task in step S150 of FIG. 4B. Similarly, when a sleep-mode shifting instruction directed to its slave 10b is sent from the master 10a operating in a normal mode except for the partial mode, the microcomputer 50 also starts to perform the sleep-mode shifting task in step S150.

Specifically, in step S150, the microcomputer 50 receives the first shift instruction or the sleep-mode shifting instruction directed to its slave 10b, and controls the power source 40 to shut off power supply thereto in step S160. This shifts the microcomputer 50 to the sleep mode while the transceiver 60 is continuously operating in the wakeup mode.

Returning to step S100, when determining that the sleep-mode shifting task has not been started yet (NO in step S100), the microcomputer 50 terminates the wakeup-ID writing task.

Otherwise, when determining that the sleep-mode shifting task has been started (YES in step S100), the microcomputer 50 reads the wakeup ID stored in the nonvolatile memory 50a, and writes the wakeup ID into the wakeup-ID holding memory 64 in step S110. Thereafter, the microcomputer 50 terminates the wakeup-ID writing task.

As a result, the wakeup ID of its slave 10b is held in the wakeup-ID holding memory 64.

Next, a wakeup determination task carried out by the wakeup determination module 65 of the transceiver 60 of each slave 10b will be described hereinafter with reference to FIG. 5. The wakeup determination task is, for example, cyclically performed by the wakeup determination module 65 of each slave 10b while the microcomputer 50 is operating in the sleep mode. For example, the wakeup determination module 65 can be configured as a controller of each slave 10b for controlling the transmitter 31, receiver 32, and timing generator 33.

When transmission data TX is sent from the master 10a in the first communication mode, the wakeup determination module 65 receives the transmission data TX as received data RX, and determines whether the wakeup ID of its slave 10b has been held in the wakeup-ID holding memory 64 in step S200. When determining that the wakeup ID of its slave 10b has been held in the wakeup-ID holding memory 64 (YES in step S200), the wakeup determination module 65 carries out the operation in step S210. Otherwise, when determining that the wakeup ID of its slave 10b has not been held in the wakeup-ID holding memory 64 (NO in step S200), the wakeup determination module 65 carries out the operation in step S230.

In step S210, the wakeup determination module 65 compares the received data RX with the wakeup ID held in the wakeup-ID holding memory 64 bit by bit. Next, in step S220, the wakeup determination module 65 determines whether the received data RX is matched with the wakeup ID held in the wakeup-ID holding memory 64 using the results of comparison.

When determining that the received data RX is matched with the wakeup ID held in the wakeup-ID holding memory 64 using the results of comparison (YES in step S220), the wakeup determination module 65 outputs, to the power source 40, the power-supply restart signal; the power supply restart signal enables the power source 40 to restart power supply to the microcomputer 50, so that the microcomputer 50 shifts from the sleep mode to the wakeup mode. In addition, the wakeup determination module 65 sends, to the receiver 32, the reception enabling signal. The reception enabling signal enables the receiver 32 to transmit received data RX based on transmission data TX on the communication bus 70 to the microcomputer 50 in step S230.

Otherwise, when determining that the received data RX is not matched with the wakeup ID held in the wakeup-ID holding memory 64 using the results of comparison (NO in step S220), the wakeup determination module 65 sends, to the receiver 32, a reception disabling signal. The reception disabling signal disables the receiver 32 from sending received data RX to the microcomputer 50 in step S240. In addition, the wakeup determination module 65 outputs, to the power source 40, a power-supply disabling signal; the power supply disabling signal continuously disables the power source 40 from supplying power to the microcomputer 50 in step S240. This results in: the microcomputer 50 maintaining itself in the sleep mode; and transmission of received data RX being blocked to the microcomputer 50.

On the other hand, in step S230, the wakeup determination module 65 outputs, to the power source 40, the power-supply restart signal, and sends, to the receiver 32, the reception enabling signal to the receiver 32 set forth above.

Next, overall operations of the communication system 1 and technical effects achieved by the communication system 1 will be described hereinafter.

When it is determined that the sleep-mode shifting task has been started according to the first shift instruction directed to a target slave 10b (YES in step S100), the wakeup ID of the target slave 10b is written by the microcomputer 50 into the wakeup-ID holding memory 64 (see step S110).

When the wakeup-ID has been held in the wakeup-ID holding memory 64 (YES in step S200), received data RX is compared with the wakeup ID held in the wakeup-ID holding memory 64 by the wakeup determination module 65 (see step S210).

When it is determined that the received data RX is matched with the wakeup ID held in the wakeup-ID holding memory 64 on the basis of the results of comparison (see YES in step S220), the power-supply restart signal is outputted from the wakeup determination module 65 to the power source 40, and the reception enabling signal is sent from the wakeup determination module 65 to the receiver 32 (see step S230).

The power supply restart signal enables the power source 40 to restart power supply to the microcomputer 50, so that the microcomputer 50 shifts from the sleep mode to the wakeup mode, and the reception enabling signal enables the receiver 32 to transmit received data RX based on transmission data TX on the communication bus 70 to the microcomputer 50.

Specifically, during the communication system 1 operating in the partial mode, it is necessary to set a unique wakeup ID to each slave 10b in order to individually instruct each slave 10b to shift to the wakeup mode from the sleep mode.

However, if the communication system were configured such that each slave 10b stored therein a unique wakeup ID, this configuration could reduce the productive efficiency of the communication system because it could be difficult to mass-produce the slaves 10b.

In contrast, the communication system 1 according to this embodiment is configured such that a wakeup ID uniquely defined in each slave 10b is stored in the microcomputer 50 of a corresponding slave 10b;

this microcomputer 50 of each slave 10b is uniquely designed for a corresponding slave 10b. This configuration allows the wakeup ID to be written into the wakeup-ID holding memory 64 of the transceiver 60 as a given timing.

Thus, it is possible for each slave 10b to determine whether a wakeup ID sent from the master 10a is matched with the wakeup ID held in the wakeup-ID holding memory 64. That is, the configuration of the communication system 1 makes it possible to shift slaves 10b, individually directed to shift to the wakeup mode, to the wakeup mode using general purpose transceivers 60.

In addition, when it is determined that the sleep-mode shifting task has been started (YES in step S100), the wakeup ID is sent to the transceiver 60 to be written into the wakeup-ID holding memory 64 (see step S110). This allows the wakeup ID stored in the microcomputer 50 to be written into the wakeup-ID holding memory 64 of the transceiver 60 at a suitable timing.

The communication system 1 is configured such that received data RW is compared with the wakeup ID held in the wakeup-ID holding memory 64 by the comparator 63 (see step S210), and the power supply restart signal is outputted to the power source 40 if the received data RX is matched with the wakeup ID held in the wakeup-ID holding memory 64 (see steps S220 and S230). This makes it possible to shift the microcomputer 50 to the wakeup mode without using complicated circuit structures.

If the received data RX is matched with the wakeup ID held in the wakeup-ID holding memory 64, the communication system 1 is also configured such that the reception enabling signal is sent to the receiver 32 (see steps S220 and S230). This configuration enables received data RX based on transmission data TX on the communication bus 70, which is received after the received data RX is matched with the wakeup ID, to the microcomputer 50.

Moreover, the communication system 1 is configured to wake up a slave 10b even if the wakeup ID of its slave 10b has not been held in the wakeup-ID holding memory 64 (NO in step S200, and S230). This configuration allows a slave 10b, which is not a target slave to be shifted to the wakeup mode, to be shifted to the wakeup mode, making it possible for a slave 10b, which is not a target slave to be shifted to the wakeup mode, to perform previously allocated functions.

Because the wakeup-ID holding memory 64 is designed as a nonvolatile memory, the wakeup ID is continuously held in the wakeup-ID holding memory 64 independently of whether the slave 10b is powered on or off. This configuration eliminates the -need to rewrite the wakeup ID into the wakeup-ID holding memory 64 each time the slave 10b (transceiver 60) is powered on.

In the embodiment, the communication system 1 corresponds to a communication system according to the first exemplary aspect of the present disclosure, and the master 10a and slave 10b correspond respectively to the master node and the slave node according to the first exemplary aspect of the present disclosure. The communication bus 70 corresponds to a communication bus according to the first exemplary aspect of the present disclosure.

The transceiver 60, the wakeup-ID holding memory 64, and the wakeup determination module 65 correspond respectively to a transceiver, a memory, and a wakeup determiner according to the first exemplary aspect of the present disclosure. The microcomputer 50, the wakeup-ID writer 52, and the power source 40 correspond respectively to a signal processor, a writing unit, and a power source according to the first exemplary aspect of the present disclosure. The wakeup ID written into the wakeup-ID holding memory 64 corresponds to wakeup information according to the first exemplary aspect of the present disclosure, and received data RX via the communication bus 70 corresponds to information received via the communicate bus according to the first exemplary aspect of the present disclosure.

The present disclosure is not limited to the above-mentioned embodiment, and therefore can include various modifications of the embodiment within the scope thereof.

In the embodiment, received data RW based on PWM code is compared with the wakeup ID based on PWM code and held in the wakeup-ID holding memory 64 by the comparator 63, but decoded received data RXD based on NRZ code can be compared with the wakeup ID based on NRZ code and held in the wakeup-ID holding memory 64.

In the embodiment, each slave 10b is comprised of the microcomputer 50 and the transceiver 60, but it can be comprised of the transceiver 60 and a signal processing unit (module), such as a sequencer, which corresponds to a signal processor according to the first exemplary aspect of the present disclosure.

While an illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A communication system comprising:
a communication bus;
a master node; and
a slave node communicably coupled to the master node via the communication bus, the master node, while the communication system is operating in a partial mode, instructing the slave node, which is operating in a sleep mode, to shift to a wakeup mode, the wakeup mode being an operation mode in which the slave node enables execution of all functions allocated thereto, the sleep mode being an operation mode in which the slave node disables execution of at least some functions allocated thereto,
the slave node comprising:
a signal processor that stores therein wakeup information uniquely defined for the slave node, the signal processor comprising a writing unit configured to write the wakeup information into the transceiver at a given timing; and
a transceiver comprising:
a memory, the wakeup information being written into the memory to be held therein; and
a wakeup determiner that compares information received via the communication bus with the wakeup information held in the memory if the slave node is operating in the sleep mode, and determines whether the slave node should shift to the wakeup mode according to a result of the comparison.

2. The communication system according to claim 1, wherein the writing unit is configured to write the wakeup information into the memory of the transceiver when an instruction is sent from the master node via the communication bus, the instruction instructing the slave node to shift to the sleep mode.

3. The communication system according to claim 1, wherein the slave node comprises a power unit that supplies operating power to the signal processor, and when the slave node is operating in the sleep mode, the power source shuts off the supply of the operating power to the signal processor, and the wakeup determiner is configured to output, to the power source, a signal to restart supply of the operating power to the signal processor to shift the slave node to the wakeup mode when the information received via the communication bus is matched with the wakeup information held in the memory.

4. The communication system according to claim 1, wherein the transceiver comprises a receiver that receives information transmitted via the communication bus, the receiver disables output of received information to the signal processor when the slave node is operating in the sleep mode, and the wakeup determiner is configured to output an enabling signal to the receiver for shifting the slave node to the wakeup mode when the information received via the communication bus is matched with the wakeup information held in the memory, the enabling signal enabling the receiver to output the received information to the signal processor.

5. The communication system according to claim 1, wherein the wakeup determiner is configured to determine that the slave node should shift to the wakeup mode even if no wakeup information is held in the memory.

6. The communication system according to claim 1, wherein the memory is a nonvolatile memory.

7. A slave node communicably coupled to a master node via a communication bus, while the master node is operating in a partial mode, the master node instructing the slave node to shift from a sleep mode to a wakeup mode, the wakeup mode being an operation mode in which the slave node enables execution of all functions allocated thereto, the sleep mode being an operation mode in which the slave node disables execution of at least some functions allocated thereto,
the slave node comprising:
a signal processor that stores therein wakeup information uniquely defined for the slave node, the signal processor comprising a writing unit configured to write the wakeup information into the transceiver at a given timing; and
a transceiver comprising:
a memory, the wakeup information being written into the memory to be held therein; and
a wakeup determiner that compares information received via the communication bus with the wakeup information held in the memory if the slave node is operating in the sleep mode, and determines whether the slave node should shift to the wakeup mode according to a result of the comparison.

8. The slave node according to claim 7, wherein the writing unit is configured to write the wakeup information into the memory of the transceiver when an instruction is sent from the master node via the communication bus, the instruction instructing the slave node to shift to the sleep mode.

9. The slave node according to claim 7, further comprising a power unit that supplies operating power to the signal processor, and when the slave node is operating in the sleep mode, the power source shuts off the supply of the operating power to the signal processor, and the wakeup determiner is configured to output, to the power source, a signal to restart supply of the operating power to the signal processor to shift the slave node to the wakeup mode when the information received via the communication bus is matched with the wakeup information held in the memory.

10. The slave node according to claim 7, wherein the transceiver comprises a receiver that receives information transmitted via the communication bus, the receiver disables output of received information to the signal processor when the slave node is operating in the sleep mode, and the wakeup determiner is configured to output an enabling signal to the receiver for shifting the slave node to the wakeup mode when the information received via the communication bus is matched with the wakeup information held in the memory, the enabling signal enabling the receiver to output the received information to the signal processor.

11. The slave node according to claim 7, wherein the wakeup determiner is configured to determine that the slave node should shift to the wakeup mode even if no wakeup information is held in the memory.

12. The slave node according to claim 7, wherein the memory is a nonvolatile memory.
